(19) United States
(12) Patent Application Publication
(10) Pub. No.: US 2015/0235543 A1
(43) Pub. Date: Aug. 20, 2015

(54) Network Switch With Enhanced Interface

(71) Applicant: Alcatel-Lucent USA Inc., Murray Hill, NJ (US)

(72) Inventors: Bryan J. Dietz, Lake Forest, CA (US); Brad Magnani, Moorpark, CA (US); Eric W. Tolliver, Moorpark, CA (US); Edgard Vargas, Moorpark, CA (US); Anu Sukhija, Calabasas, CA (US); Khurram Khawaja, Simi Valley, CA (US)

(73) Assignee: ALCATEL-LUCENT USA INC., Murray Hill, NJ (US)

(21) Appl. No.: 14/626,040

(22) Filed: Feb. 19, 2015

Related U.S. Application Data
(60) Provisional application No. 61/945,971, filed on Feb. 28, 2014.
(60) Provisional application No. 61/941,880, filed on Feb. 19, 2014.

(51) Int. Cl. G08B 21/18

(52) U.S. Cl. CPC G08B 21/18

(57) ABSTRACT

A network switch is provided that has an enhanced interface wherein an integrated circuit device is provided that facilitates the delivery of enhanced status information from the network switch. This integrated circuit, illustratively, a field programmable gate array (FPGA) or programmable logic device (PLD) such as a complex programmable logic device (CPLD), facilitates the delivery of enhanced status indicator information in conjunction with the resident networking switch semiconductor device (i.e., an Ethernet switch or PHY device). The enhanced status indicator information is conveyed using more LEDs (i.e., more than the resident networking semiconductor device contains by itself), and thus more information can be displayed and conveyed by such LEDs.

### RELATED APPLICATIONS

This application claims the benefit of U.S. Provisional Application No. 61/941,880 filed Feb. 19, 2014, and U.S. Provisional Application No. 61/945,971 filed Feb. 28, 2014, each of which are incorporated herein by reference.

### TECHNICAL FIELD

The present invention relates generally to network switches, and more particularly, to network switches that have an enhanced display interface and functionality to communicate a wider range of status information useful in operating and maintaining the network switch.

### BACKGROUND OF THE INVENTION

Today, in the Internet era, it is paramount to have reliable and efficient access to information, applications and content. For example, individuals, professionals and academics in business and academic arenas have become accustomed to and rely on computer networks for the delivery of a wide variety of software applications, electronic mail, remote database access and Internet connectivity in their everyday activities. At home, individuals have a multiplicity of networked devices for the delivery of a variety of communication and entertainment services. As such, computer networking technologies have become increasingly pervasive and necessary in the delivery of fast, efficient and reliable connectivity.

A popular delivery mechanism of such computer networks is by and through local area network (LANs) and/or wide area networks (WANs) which allow for independent computers to exchange information with each other over a shared communication medium in a limited geographic area (i.e., LAN) or wide area which combines multiple LANs (i.e., WAN). In many cases, LAN configuration and delivery is accomplished using a standardized protocol known as Ethernet.

Ethernet is a popular physical layer LAN technology and provides for connectivity requirements, performance thresholds and data transmission frameworks. The Ethernet standard developed by the Institute for Electrical and Electronic Engineers (IEEE) is known as IEEE 802.3 and sets forth a standard set of rules for configuring an Ethernet network and specifies how the various network elements interact with each other. The widespread acceptance of the Ethernet standard is generally attributed to the standard's balance between speed, cost and ease of installation. By adhering to this well-known IEEE standard, networking equipment can be manufactured for efficient interoperability and network protocols utilized for more consistent and efficient communication.

Most modern Ethernet networks are switched networks that include multiple nodes (i.e., individual devices or stations), switches and connections there between which are typically made using twisted-pair copper cable or fiber optic cable. Such switches receive and selectively forward information such that data and control signals are properly transmitted from source to destination. These switched networks can accommodate large numbers of nodes and dedicated segments, at various geographical distances, while delivering a range of transmission speeds from 10Mbps to 100 Gbps. Each network switch is typically configured from and includes one or more semiconductor devices designed for such purposes.

In operation, these commercial network switches utilize illuminated displays to communicate operational, status and/or debugging information to users related to, for example, connectivity, activity levels, and speed. For example, the status or debugging information is displayed and utilized by maintenance and IT operations personnel responsible for operating and maintaining the network. The semiconductor devices (also referred to herein as status circuits) that form the network switch typically have one or more built-in light emitting diodes (LEDs) that are driven by status circuitry resident in the semiconductor devices for this purpose and provide a limited amount of status information that is available from the device itself. That is, the status information provided is device centric and does not include status or debugging information that is available external to the particular device. Expanding the available (and, in turn, displayable) information to such semiconductor devices will improve the operation, maintenance and/or debugging of the network switch by the responsible IT personnel as they will be able to take action based on a larger set of information.

One solution for expanding the range of display information is to duplicate the dedicated status circuit(s) within the semiconductor device that drives the LED (or other status functions) and directly include the additional information. However, this approach is limited by the overall cost and design complexity, and the availability of additional information external to the device.

Therefore, a need exists for an improved display interface that will increase the type and amount of available status information while limiting the design complexity necessary for implementation.

### BRIEF SUMMARY OF EMBODIMENTS

In accordance with various embodiments, an enhanced display interface is provided wherein an integrated circuit device is provided that facilitates the delivery of enhanced status information from, for example, a network switch. This integrated circuit, illustratively, a field-programmable gate array (FPGA) or programmable logic device (PLD) such as a complex programmable logic device (CPLD), facilitates the delivery of enhanced status indicator information in conjunction with the resident networking switch semiconductor device (i.e., an Ethernet switch or PHY device, each of which includes a status circuit for driving LEDs). In accordance with various embodiments, the enhanced status indicator information is conveyed using a plurality of indicators that includes using more LEDs (i.e., more than the number of LEDs of the resident networking semiconductor device itself), and thus more information can be displayed and conveyed by such LEDs.

The integrated circuit device is coupled, illustratively, to a PHY semiconductor device or Ethernet switch semiconductor device that is resident in the network node configuration. The coupled integrated circuit device receives a first set of status indicator information, from the status circuit of the PHY device or Ethernet device, that is the basic LED status information (hereinafter also referred to as the “Basic Status Indicator Information”) available from the resident PHY device or Ethernet switch device. That is, for example, the FGPA or CPLD is connected to the basic LED signals from the resident PHY semiconductor device or Ethernet switch semiconductor device in defining a first set of status indicator information. In addition, in accordance with an embodiment, the integrated circuit has a plurality registers and is also coupled to another processing device of the network switch, for example, a management microprocessor or central processing unit (CPU) which provides a second set of status indicator information (hereinafter also referred to as “Additional Status Indicator Information”) that is different from, and unavailable to, the status information available from the resident PHY semiconductor device or Ethernet switch semiconductor device (i.e., the first set of status indicator information).

For example, the Additional Status Indicator Information may include additional colors to represent multiple port states and/or unique patterns of LED flashes to identify particular problems that are beyond those represented by the Basic Status Indicator Information. The Additional Status Indicator Information is provided by updating the plurality of registers of the FPGA or CPLD which then combines (through well-known logic residing on the FPGA or CPLD) this with the Basic Status Indicator Information to create a set of enhanced status indicator information as an output, illustratively, and illuminated via a set of LED signals displayable by the network switch.

In a further embodiment, a method is provided for an enhanced display interface, illustratively on a network node, wherein the method includes receiving basic status indicator information (i.e., a first set of status indicator information) from a device on the node (and, if necessary, decoding the basic status indicator information), receiving communications containing additional status indicator information (i.e., a second set of status indicator information) from, illustratively, a management microprocessor, generating a set of enhanced status indicator information from the first and second set of status indicator information and outputting the enhanced set of status indicator information.

These and other advantages will be apparent to those of ordinary skill in the art by reference to the following detailed description and the accompanying drawings.

### BRIEF DESCRIPTION OF THE DRAWINGS

FIG. 1 shows an illustrative switched Ethernet local area network configuration in accordance with an embodiment;

FIG. 2 shows an illustrative network switch configured in accordance with an embodiment;

FIG. 3 shows an illustrative network switch configured in accordance with an alternative embodiment; and

FIG. 4 shows a flowchart of illustrative operations for providing an enhanced display interface in accordance with an embodiment; and

FIG. 5 is a high-level block diagram of an exemplary computer in accordance with an embodiment.

### DETAILED DESCRIPTION

In accordance with various embodiments, an enhanced display interface is provided, illustratively on a network node, wherein an integrated circuit device is provided that facilitates the delivery of enhanced status indicator information from a network switch. This integrated circuit, illustratively, an FPGA or PLD device such as a CPLD, provides enhanced status indicator information in conjunction with the resident networking switch semiconductor device (i.e., an Ethernet switch or PHY device; each of which has a status circuit for driving LEDs). As will be readily understood, “PHY” as used herein is an abbreviation for the physical layer of the Open Systems Interconnection Model (OSI) which is directed to the so-called “seven layer model” that defines how communication networks work and interoperate. A PHY semiconductor device, as commonly found on Ethernet semiconductor devices, connects a link layer device (i.e., media access control (MAC)) to a physical medium such as an optical fiber. In the Ethernet context, the PHY device provides a link with analog signal physical access and is commonly interfaced to a microcontroller that facilitates higher OSI layer functionality. In accordance with various embodiments, the enhanced status indicator information is conveyed using a plurality of indicators that includes using more LEDs (i.e., more than the number of LEDs of the resident networking semiconductor device itself), and thus more information can be displayed and conveyed by such LEDs.

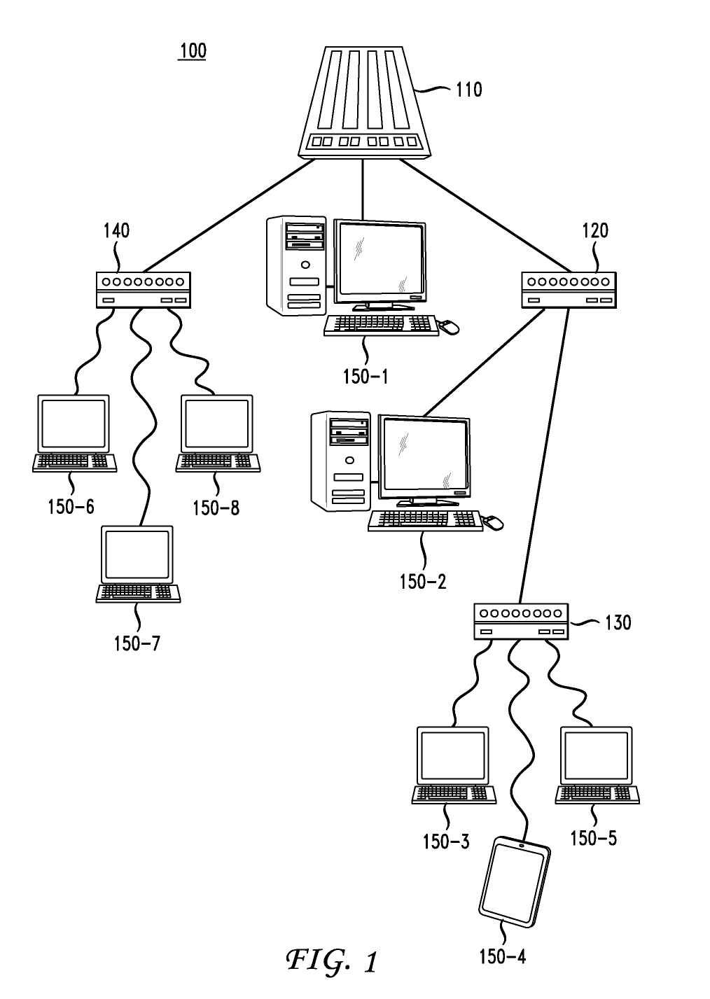

FIG. 1 shows an illustrative switched Ethernet LAN 100 configured in accordance with an embodiment. As shown, Ethernet LAN 100 has three (3) Ethernet switches: switch 110, switch 120, and switch 130, and one (1) Ethernet hub: hub 140. Ethernet LAN 100 has a conventional and well understood configuration that delivers a switched Ethernet network accessible by a plurality of devices 150-1 through 150-8. For example, the plurality of devices 150-1 through 150-8 may be some combination of personal computers, laptops, and notebooks. As will be readily understood, Ethernet switches 110, 120, and 130 will typically include at least one Ethernet semiconductor switch device and at least one PHY semiconductor device. Further, while the discussion herein will be focused on illustrative switch configurations it will be understood that the principles of such embodiments will apply equally to a hub, for example, hub 140, or other devices that utilize status information and status displays in their operations.

In accordance with an embodiment, a network node is provided, for example, switch 130 with an enhanced display interface providing the capacity to utilize and operate with enhanced status indicator information. As will be readily understood, Ethernet semiconductor switch devices and PHY semiconductor devices (i.e., the status circuits) typically supply basic port state information to drive one LED per port. For example, the LED may be ON if the port is operational and/or the LED may flash if data is currently being transferred.

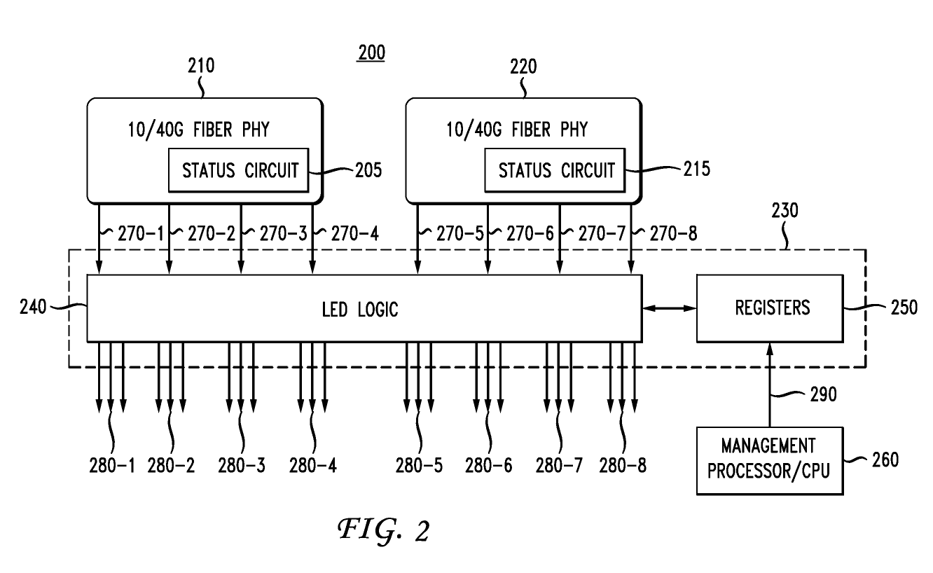

FIG. 2 shows an illustrative network switch 200 configured in accordance with an embodiment. In this embodiment, network switch 200 includes PHY device 210 having status circuit 205, PHY device 220 having status circuit 215 (e.g., each designed for 10/40G optical applications), and management processor/CPU 260. In accordance with this embodiment, FPGA 230 is provided and connected to a plurality of status indicators that are the basic LED signals, i.e., LED signals 270-1 through 270-8 available from PHY device 210 and PHY device 220, respectively. The basic LED signals 270-1 through 270-8 (which are the manifestation of the Basic Status Indicator Information) are well understood for such commercial devices. Also, while FPGA 230 is shown and described in this embodiment it will be understood that a CPLD could be utilized in the same fashion and deliver the same advantages of the embodiment. Further, while management processor/CPU 260 is shown as a separate device it will be understood that such processor could be incorporated directly into the Ethernet switch device or PHY device (e.g., PHY device 210 or PHY device 220) as well.

In accordance with the embodiment, FPGA 230 contains a plurality of registers 250 such that operations executing on management microprocessor/CPU 260 periodically updates, across communications link 290, these registers to reflect additional status information (i.e., a second set of status indicator information) that is not available to or from PHY device 210 or PHY device 220 (via status circuit 205 and status circuit 215, respectively) and, therefore, not reflected in basic LED signals, 270-1 through 270-8. That is, the additional status information provided from management microprocessor/CPU 260 is different than the first set of status indicator information provided by PHY device 210 and/or PHY device 220. As such, FPGA 230 includes LED logic 240 that is utilized to combine the basic LED signals 270-1 through 270-8 with the contents of the plurality of registers 250 to create enhanced LED signals 280-1 through 280-8 (which are the manifestation of the enhanced status indicator information) which contain additional information. For example, enhanced LED signals 280-1 through 280-8 may include additional colors to represent multiple port states and/or unique patterns of LED flashing to identify specific problems not shown in the basic LED signals. Advantageously, in accordance with various embodiments, one or more multi-color LEDs are realized through this implementation. The indicators represented by enhanced LED signals 280-1 through 280-8 will be readily understood. Also, as shown in FIG. 2, the number of LEDs represented by enhanced LED signals 280-1 through 280-8 are equal to or greater in number (both collectively and on a per port basis) than that of basic LED signals 270-1 through 270-8.

Advantageously, the above-detailed embodiment requires only a modest amount of external hardware and software logic to accept the basic LED status information (e.g., as provided by the status circuit 205 of PHY device 210 and status circuit 215 of PHY device 220, respectively), process such information in combination with the additional LED status information (e.g., as provided by management processor/CPU 260) and create an enhanced status indicator information set that facilitates additional displays or trigger other actions. For example, in addition to generating the enhanced LED status display, FPGA 230 could take actions based on the combined status (i.e., the Basic Status Indicator Information and the Additional Status Indicator Information) to activate external hardware for alarms or protection switching. As such, the various embodiments herein provide a straightforward solution to provide an enhanced display interface without excessive costs or complexity.

To further illustrate the above-described embodiment and the advantages thereof, the following examples illustrate how this embodiment could be used to produce multicolored LED status displays. As detailed above, in accordance with the embodiment, enhanced LED signals 280-1 through 280-8 may include additional colors to represent multiple port states and/or unique patterns of LED flashing to identify specific problems not shown (or capable of being shown) in the basic LED signals (e.g., as from PHY device 210 or PHY device 220). As such, a red-blue-green (RGB) LED (i.e., tri-color LED) provides the following colors, as shown in Table 1, in accordance with this enhanced display interface embodiment:

TABLE 1

| Additional Status Indicator Information | Status - Color |
|---|---|
| 000 | Off |
| 100 | Red |
| 110 | Yellow |
| 010 | Green |
| 001 | Blue |
| 111 | White |
| 101 | Magenta |
| 011 | Cyan |

Using the enhanced display interface of the above-described embodiment, the enhanced and additional multi-color LED set can be used to identify a variety of different functions that are useful in operating, maintaining and/or debugging a network switch (e.g., switch 130) as shown in the following Table 2:

TABLE 2

| Additional Status Indicator | | | |
|---|---|---|---|
| Information | Port Type | Solid | Flashing |
| Green | 40 G | Link | Activity |
| Yellow | 10 G | Link | Activity |
| Blue | VFL (any 10G | Link | Activity |
| | or | | |
| White | Port Error | Beacon | SW defined |
| | | | error: |
| | | | cycling |
| | | | between |
| Red | Error | SW defined | — |
| Magenta | — | X | X |
| Cyan | — | X | X |

Some of the illustrative states displayed above in Table 2 are related dual speed ports (400 vs. 100) where the port operates as several sub-ports when in low speed mode. For example, the white color LED example in Table 2 shows: if subport 1 (100) is bad, the LED will blink as follows: yellow, white, yellow, white, yellow, white (i.e., indicating that subport 1 is bad since the white LED only blinks one time, and the yellow blinking in between signifies other subports (e.g., 2, 3, 4) are working properly.

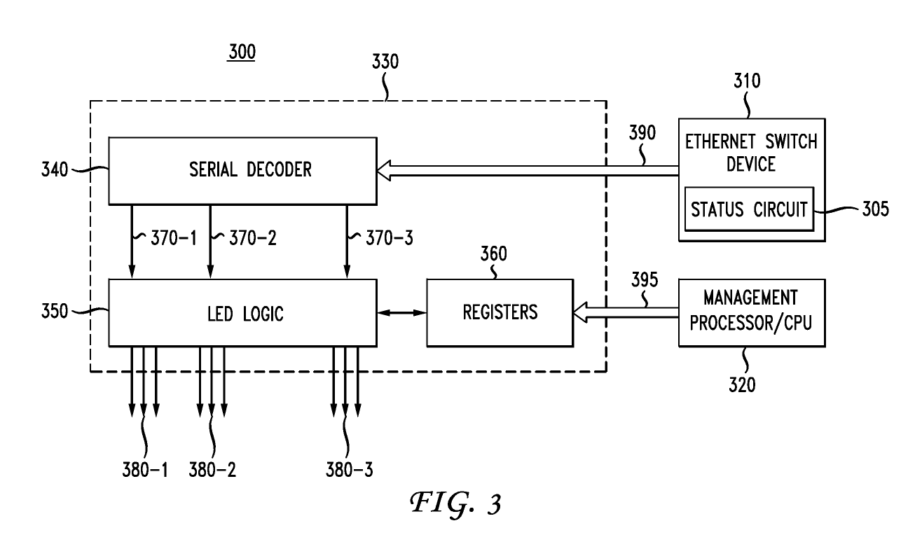

As detailed above and shown in the embodiment of FIG. 2, the status output from PHY 210 or PHY 220 is typically used to drive an indicator such as an LED. That is, a number of status outputs are available and are provided as a separate signal for each LED. In accordance with a further embodiment shown in FIG. 3, the output for a plurality of status outputs are combined and delivered as one or more serial outputs. That is, in accordance with this further embodiment, the Ethernet switch or PHY semiconductor device provides a serial bit stream containing multiplexed status information intended for multiple LEDs.

In particular, FIG. 3 shows an illustrative network switch 300 configured in accordance with such further embodiment. In this embodiment, network switch 300 includes FPGA 330 and Ethernet switch device 310 having status circuit 305 which provides serial bit stream 390 that contains multiplexed status information intended for multiple LEDs. In accordance with this embodiment, FPGA 330 includes serial decoder 340 having logic which will decode serial bit stream 390 transmitted from switch device 310 using well understood serial-to-parallel conversion. The decoded serial bit stream, therefore, will be output as the basic LED signals from switch 310, i.e., LED signals 370-1 through 370-3 (the manifestation and display of the Basic Status Indicator Information). Also, while FPGA 330 is shown and described in this embodiment it will be understood that a CPLD could be utilized in the same fashion and deliver the same advantages of the embodiment.

In accordance with the embodiment, FPGA 330 contains a plurality of registers 360 such that operations executing on management microprocessor/CPU 320 periodically updates these registers, across communications link 395, to reflect a second set of status indicator information that is different from the first set of status indicator information and not available to switch device 310 (i.e., no available from status circuit 305) and, therefore, not reflected in basic LED signals, 370-1 through 370-3. As such, FPGA 330 includes LED logic 350 that is utilized to combine the incoming Basic Status Indicator Information (i.e., LED signals 370-1 through 370-3) with the contents of the plurality of registers 360 to create a set of enhanced status indicator information and represented by enhanced LED signals 380-1 through 380-3 which display additional information. For example, as described above, enhanced LED signals 380-1 through 380-3 may include additional colors (i.e., multi-color LEDs) to represent multiple port states and/or unique patterns of LED flashing to identify specific problems not shown in the basic LED signals. The indicators represented by enhanced LED signals 380-1 through 380-3 will be readily understood. Again, advantageously, the number of LEDs represented by enhanced LED signals 380-1 through 380-3 are equal to or greater in number (both collectively and on a per port basis) than that of basic LED signals 370-1 through 370-3.

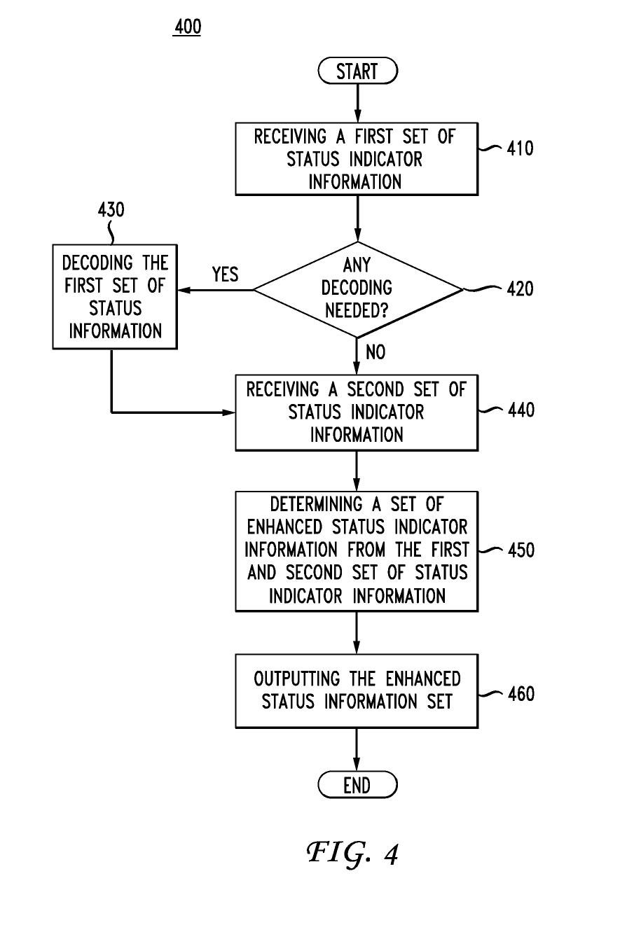

FIG. 4 shows a flowchart of illustrative operations 400 for providing an enhanced display interface in accordance with an embodiment. In accordance with this embodiment, a first set of status indicator information is received (block 410), illustratively, the Basic Status Indicator Information. In this step, the Basic Status Indicator Information is transmitted from the network node, for example, by an Ethernet switch or PHY device (i.e., a status circuit) as detailed herein above. Alternative embodiments herein may utilize a serial bit stream containing multiplexed status information transmitted by the Ethernet switch or PHY device. As such, a determination is made and decoding of the first set of status indicator information is made when necessary (block 420 and block 430). In accordance with the embodiment, a second set of status indicator information is received (block 440), for example, as transmitted by a management processor/CPU and including enhanced LED status information (i.e., the Additional Status Indicator Information). Thus, a set of enhanced status indicator information is determined using both the first and second set of status indicator information (block 450) and outputted (block 460), illustratively, from a plurality of status indicators of the network node. For example, enhanced LED signals may be utilized and provide additional colors to represent multiple port states and/or unique patterns of LED flashing to identify specific problems not shown in the basic LED signals. Advantageously, the above-detailed embodiment will accept the basic LED status information, process such information in combination with the enhanced LED status information and create additional displays or trigger other actions (e.g., activate external hardware for alarms or protection switching).

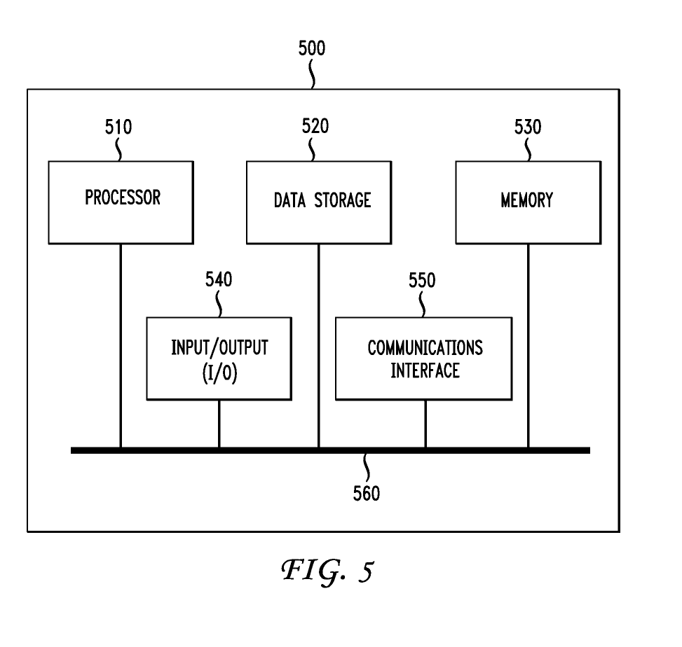

As detailed above, the various embodiments herein can be embodied in the form of methods and apparatuses for practicing those methods. The disclosed methods may be performed by a combination of hardware, software, firmware, middleware, and computer-readable medium (collectively “computer”) installed in and/or communicatively connected to a user device or network node, for example. FIG. 5 is a high-level block diagram of an exemplary computer 500 that may be used for implementing a method for providing an enhanced interface in accordance with the various embodiments herein. Computer 500 comprises a processor 510 operatively coupled to a data storage device 520 and a memory 530. Processor 510 controls the overall operation of computer 500 by executing computer program instructions that define such operations. Communications bus 560 facilitates the coupling and communication between the various components of computer 500. The computer program instructions may be stored in data storage device 520, or a non-transitory computer readable medium, and loaded into memory 530 when execution of the computer program instructions is desired. Thus, the steps of the disclosed method (see, e.g., FIG. 4 and the associated discussion herein above) can be defined by the computer program instructions stored in memory 530 and/or data storage device 520 and controlled by processor 510 executing the computer program instructions. For example, the computer program instructions can be implemented as computer executable code programmed by one skilled in the art to perform the illustrative operations defined by the disclosed method. Accordingly, by executing the computer program instructions, processor 510 executes an algorithm defined by the disclosed method. Computer 500 also includes one or more communication interfaces 550 for communicating with other devices via a network (e.g., a wireless communications network) or communications protocol (e.g., Bluetooth®). For example, such communication interfaces may be a receiver, transceiver or modem for exchanging wired or wireless communications in any number of well-known fashions. Computer 500 also includes one or more input/output devices 540 that enable user interaction with computer 500 (e.g., camera, display, keyboard, mouse, speakers, microphone, buttons, etc.).

Processor 510 may include both general and special purpose microprocessors, and may be the sole processor or one of multiple processors of computer 500. Processor 510 may comprise one or more central processing units (CPUs), for example. Processor 510, data storage device 520, and/or memory 530 may include, be supplemented by, or incorporated in, one or more application-specific integrated circuits (ASICs) and/or one or more field programmable gate arrays (FPGAs).

Data storage device 520 and memory 530 each comprise a tangible non-transitory computer readable storage medium. Data storage device 520, and memory 530, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 540 may include peripherals, such as a camera, printer, scanner, display screen, etc. For example, input/output devices 640 may include a display device such as a cathode ray tube (CRT), plasma or liquid crystal display (LCD) monitor for displaying information to the user, a keyboard, and a pointing device such as a mouse or a trackball by which the user can provide input to computer 500.

It should be noted that for clarity of explanation, the illustrative embodiments described herein may be presented as comprising individual functional blocks or combinations of functional blocks. The functions these blocks represent may be provided through the use of either dedicated or shared hardware, including, but not limited to, hardware capable of executing software. Illustrative embodiments may comprise digital signal processor (“DSP”) hardware and/or software performing the operation described herein. Thus, for example, it will be appreciated by those skilled in the art that the block diagrams herein represent conceptual views of illustrative functions, operations and/or circuitry of the principles described in the various embodiments herein. Similarly, it will be appreciated that any flowcharts, flow diagrams, state transition diagrams, pseudo code, program code and the like represent various processes which may be substantially represented in computer readable medium and so executed by a computer, machine or processor, whether or not such computer, machine or processor is explicitly shown. One skilled in the art will recognize that an implementation of an actual computer or computer system may have other structures and may contain other components as well, and that a high level representation of some of the components of such a computer is for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A display interface comprising:
an integrated circuit having a plurality of status indicators, the integrated circuit configured to receive a first set of status indicator information and a second set of status indicator information, and to generate a set of enhanced status indicator information from the first set of status indicator information and the second set of status indicator information for display by at least one status indicator of the plurality of status indicators.

2. The display interface of claim 1 wherein the integrated circuit is configured to received the first set of status indicator information from a status circuit having at least one status indicator connected thereto.

3. The display interface of claim 1 wherein the integrated circuit is a field-programmable gate array (FPGA).

4. The display interface of claim 1 wherein the integrated circuit is a complex programmable logic device (CPLD).

5. The display interface of claim 1 wherein the first set of status indicator information and the second set of status indicator information are different.

6. The display interface of claim 1 wherein the set of enhanced status indicator information is useful for illuminating a set of multi-color LEDs.

7. The display interface of claim 1 wherein the plurality of status indicators are LEDs.

8. The display interface of claim 2 wherein the second set of status indicator information is provided by a management microprocessor.

9. The display interface of claim 2 wherein the status circuit is part of a network switch semiconductor device.

10. A method for driving a display on a plurality of status indicators, the method comprising:
receiving a first set of status indicator information;
receiving a second set of status indicator information; and
generating an enhanced set of status indicator information from the first set of status indicator information and the second set of status indicator information for display by at least one status indictor of the plurality of status indicators.

11. The method of claim 10 wherein the first set of status indicator information is different from the second set of status indicator information.

12. The method claim 11 wherein the second set of status indicator information is provided from a management processor.

13. The method of claim 10 further comprising:
illuminating at least one status indicator of the plurality of status indicators in accordance with the enhanced set of status indicator information.

14. The method of claim 10 wherein the first set of status indicator information has a serial format, the method further comprising:
decoding the first set of status indicator information from the serial format to a parallel format.

15. A network node comprising:
a network switching device having a first plurality of status indicators; and
an integrated circuit having a second plurality of status indicators, the integrated circuit configured to receive, from the network switching device, a first set of status indicator information related to the first set of status indicators, and to receive a second set of status indicator information, and to generate a set of enhanced status indicator information from the first set of status indicator information and the second set of status indicator information for display by the second plurality of status indicators.

16. The network node of claim 15 further comprising:
a management processor for providing the second set of status indicator information.

17. The network node of claim 15 wherein the network switching device is an Ethernet switching device.

18. The network node of claim 16 wherein the first set of status indicator information is different from the second set of status indicator information.

19. The network node of claim 17 wherein the first plurality of status indicators and the second plurality of status indicators are LEDs, and the second plurality of status indicators is larger than the first plurality of status indicators.

20. The network node of claim 19 wherein the enhanced set of status indicator information is useful for illuminating a set of multi-color LEDs.
